(19) United States
(12) Patent Application Publication
(10) Pub. No.: US 2013/0295395 A1
(43) Pub. Date: Nov. 7, 2013

(54) BIAXIALLY ORIENTED POLYPROPYLENE FILM WITH IMPROVED MOISTURE BARRIER

(71) Applicants: CLAUDIO M. PAULINO, South Kingstown, RI (US); CHRISTOPHER D. ROY, Saunderstown, RI (US)

(72) Inventors: CLAUDIO M. PAULINO, South Kingstown, RI (US); CHRISTOPHER D. ROY, Saunderstown, RI (US)

(21) Appl. No.: 13/842,551

(22) Filed: Mar. 15, 2013

Related U.S. Application Data
(60) Provisional application No. 61/639,465, filed on Apr. 27, 2012.

(51) Int. Cl. C08L 23/12; B32B 15/085

(52) U.S. Cl. CPC C08L 23/12; B32B 15/085
USPC 428/461; 525/240

(57) ABSTRACT

Embodiments herein relate to a biaxially oriented film comprising a core layer (B) comprising a blend of a high density polyethylene and a crystalline polypropylene, wherein the biaxially oriented film has a lower moisture vapor transmission rate than that of a biaxially oriented polypropylene (BOPP) film have a same structure and composition as that the biaxially oriented film except the BOPP film has the core layer (B) containing 100 wt % of the crystalline polypropylene.

### FIELD OF INVENTION

This invention relates to a multi-layer biaxially oriented polypropylene (BOPP) film with a novel formulation which exhibits improved moisture barrier properties. This improved formulation comprises a blend of high density polyethylene (HDPE) resin with polypropylene (PP) to achieve a clear PP-based film that still exhibits typical properties of BOPP films with improved moisture barrier.

### BACKGROUND OF INVENTION

Biaxially oriented polypropylene (BOPP) films used for packaging, decorative, and label applications often perform multiple functions. It must perform in a lamination to provide printability, transparent or matte appearance, or slip properties; it sometimes must provide a surface suitable for receiving organic or inorganic coatings for gas and moisture barrier properties; it sometimes must provide a heat sealable layer for bag forming and sealing, or a layer that is suitable for receiving an adhesive either by coating or laminating.

Moisture barrier properties can be improved by deposition of organic or inorganic coatings, but these processes usually affect the clarity and transparency of the BOPP films, and also add cost to the manufacturing process, and are not suitable for certain packaging applications for aesthetic reasons. Another way to improve moisture barrier properties of BOPP films is to add hydrocarbon resins to the core layer, but this option is also usually undesirable because these hydrocarbon resins are expensive, and in order to be effective they need to be used at a level that imparts significant cost to the BOPP film.

It is the objective of this invention to provide a method for achieving improved moisture barrier properties of a BOPP film using a blend of high density polyethylene (HDPE) and polypropylene (PP) resins without sacrificing optical properties such as transparency and clarity of the film and other desirable mechanical properties.

### SUMMARY OF THE INVENTION

We seek to develop blends of HDPE and PP resins to improve moisture barrier properties of BOPP films, either by sequential or simultaneous orientation and reduce cost of such BOPP film. The inventors have found a solution that utilized high density polyethylene blended with polypropylene at different levels to accomplish this objective. The use of high density polyethylene blended with polypropylene in the core layer of the film allows good clarity and transparency, improves the overall moisture barrier properties of the film, maintains good mechanical properties, and is a lower cost option than expensive hydrocarbon resins. It is also contemplated to use this formulation as part of a metallized opaque BOPP film.

### DETAILED DESCRIPTION OF THE INVENTION

Embodiments therein relate to a biaxially oriented film comprising a core layer (B) comprising a blend of a high density polyethylene and a crystalline polypropylene, wherein the biaxially oriented film has a lower moisture vapor transmission rate than that of a biaxially oriented polypropylene (BOPP) film have a same structure and composition as that the biaxially oriented film except the BOPP film has the core layer (B) containing 100 wt % of the high density polyethylene. In one embodiment, the crystalline polypropylene comprises a mini-random crystalline polypropylene homopolymer. In one embodiment, the crystalline polypropylene comprises a crystalline polypropylene homopolymer. In one embodiment, the mini-random crystalline polypropylene homopolymer comprises an antiblock. In one embodiment, the antiblock comprises a silicate antiblock. In one embodiment, an amount of high density polyethylene is about 10-80 wt % of the base layer. In one embodiment, the biaxially oriented film has a moisture vapor barrier of less than 0.5 g/100 in²/day. In one embodiment, the biaxially oriented film further comprises a metal layer on at least one side of the core layer. In one embodiment, the metal layer has an optical density of 2.0-4.0. In one embodiment, the metal layer comprises aluminum. In one embodiment, the biaxially oriented film has an oxygen gas barrier of less than 5.0 cc/100 in²/day and moisture vapor barrier of less than 0.05 g/100 in²/day. In one embodiment, the biaxially oriented film has an oxygen gas barrier of less than 3.0 cc/100 in²/day and moisture vapor barrier of less than 0.02 g/100 in²/day.

Another embodiment relates to method of manufacturing the biaxially oriented film, the method comprising manufacturing the biaxially oriented film on a sequential orientation manufacturing line using film-making conditions and tentering temperatures for manufacturing the BOPP film.

Another embodiment relates to a method of manufacturing the biaxially oriented film, the method comprising manufacturing the biaxially oriented film on a simultaneous orientation manufacturing line using film-making conditions and tentering temperatures for manufacturing the BOPP film.

Materials

High density polyethylene homopolymer, Total HDPE 9658, density 0.96 g/cc, MI 0.64 g/10 min

Mini-random crystalline polypropylene homopolymer, Total PP 3374HA, density 0.90 g/cc, MF 3.5 g/10 min with an amount of nominal 3.0 μm spherical sodium calcium aluminum silicate antiblock of about 300 ppm loading,

Crystalline polypropylene homopolymer, Total PP 3271, density 0.90 g/cc, MF 1.6 g/10 min

Random propylene ethylene butene terpolymer, Sumitomo PP SPX78R6, density 0.90 g/cc, MF 9.5 g/10 min with an amount of nominal 2.0 μm spherical crosslinked silicone polymer antiblock of about 4000 ppm loading,

Multi-layer BOPP film was made using a 1.5m wide production line sequential orientation process with a blend of Total HDPE 9658 and Total PP 3271 as core layer (B) as detailed in the Examples and Table 1; one skin layer (A) of Total PP 3374HA crystalline propylene homopolymer on one side of the core layer (B) as detailed in the Examples; and the heat sealable layer of Sumitomo PP SPX78R6 (C) on the side of the core layer (B) opposite the skin layer (A) as detailed in Examples; via coextrusion through a die, cast on a chill drum using an air knife pinner, oriented in the machine direction at about 4.75 times through a series of heated and differentially sped rolls, followed by transverse direction stretching in a tenter oven of about 8-10 times.

The multilayer coextruded laminate sheet was coextruded at processing temperatures of ca. 220° C. to 250° C. through a die and cast onto a cooling drum whose surface temperature was controlled between 21° C. and 38° C. to solidify the non-oriented laminate sheet at a casting speed of about 8-13 mpm. The non-oriented laminate sheet was preheated in the machine direction orienter at about 93° C. to 113° C., stretched in the longitudinal direction at about 105° C. to 113° C. at a stretching ratio of about 4.75 times the original length and the resulting stretched sheet was annealed at about 24° C. to 80° C. to reduce heat shrinkage and to obtain a uniaxially oriented laminate sheet. The uniaxially oriented laminate sheet was introduced into a tenter at a linespeed of ca. 24 to 40 mpm and preliminarily heated between about 145° C. and 165° C., and stretched in the transverse direction at about 145° C. to 165° C. at a stretching ratio of about 8 times the original width and then heat-set or annealed at about 145° C. to 165° C. to reduce internal stresses due to the orientation and minimize shrinkage and give a relatively thermally stable biaxially oriented sheet.

One of the surprising findings of this invention was that these core layer blends of HDPE/PP from 0 wt % HDPE up to 80 wt % HDPE could be tentered and formed into films using standard OPP processing conditions without having to adjust conditions to compensate for the increasingly higher loadings of the lower melting point HDPE component in the core layer. No loss of film-making stability was encountered until the core layer blend approached 90 wt % HDPE and 10 wt % crystalline PP. It should be noted that this is important as the die design for the coextruded film structure was a “reduced skin” die design. This is known in the art as a die design whereby the coextruded skin layers (layers A and C, respectively of the invention) are narrower in width than the core layer B. This is done in order that the tenter chain clips—which are heated to high temperature due to its exposure within the tentering oven—grasp the exposed core layer rather than the coextruded skin layers. The reason for this is that in many multi-layer OPP film designs, a low melting point copolymer or terpolymer is often used as one of the skin layers (in this invention, layer C), and if this copolymer layer is grasped by the heated clips, the layer would melt and stick to said clips, resulting in film breaks and process instability. (A low melting point co- or terpolymer skin layer is often used to impart heat sealability properties to the OPP film.) Thus, the higher melting point exposed core layer—comprised typically of mostly crystalline polypropylene—is more thermally stable and releases from the heated clip jaws without sticking, enabling break-free and stable production of OPP films. The inventors were surprised that biaxially oriented films could be made with good stability when the core layer was blended with up to 80 wt % HDPE (and 20 wt % PP) without changing tenter conditions to lower temperatures to accommodate the higher percentage of lower melting point HDPE.

After biaxial orientation, the thickness of the coextruded film overall was nominal 70 G (17.5 μm); the sealant layer (C) was nominal 8 G (2.0 μm); the skin layer (A) was nominal 4 G (1.0 μm); and the core layer was nominal 58 G (14,5 μm). Main layer extruder output was adjusted to maintain finished film thickness of 70 G (17.5 μm) after orientation as needed. The film was heat-set or annealed in the final zone of the tenter oven to reduce internal stresses and minimize heat shrinkage of the film and maintain a dimensionally stable biaxially oriented film. The side of the skin layer A on the core layer opposite the sealable skin layer was treated via corona discharge treatment method after orientation. The BOPP multi-layer film was wound in roll form.

As a basefilm for metallization, the test rolls were placed inside a vacuum chamber metallizer for vapor deposition metallization using aluminum which is well known in the art. Aluminum deposition was on the surface of the skin layer A comprised of Total 3374HA (see below). The film was then passed into the high vacuum deposition chamber of the metallizer which was metallized using aluminum to a nominal optical density target of 2.4. Optical densities for aluminum deposition can range from 2.0 to 5.0; preferably the OD range is 2.2-3.2. The metallized rolls were then slit on a film slitter and tested for properties.

Optionally, prior to aluminum deposition, the film can be treated using a type of sputtering with a copper cathode at a linespeed of about 305 mpm. This treater is typically set up in the low vacuum section of the metallizer where the unwinding roll is located and the film is passed through this treater prior to entering the high vacuum section of the metallizer where the evaporation boats are located. The treater uses high voltage between the anode and cathode to produce free electrons. Oxygen gas is introduced into the treater and the free electrons combine with the oxygen gas to produce oxygen ions. Magnetic fields guide and accelerate the oxygen ions onto the copper cathode target which then emit copper ions. These copper ions are deposited onto the polylactic acid polymer substrate, creating a monolayer of copper, ca. 20 ng/m² (nanogram/sq. meter) thick.

The skin layer (A)—which can be used as a metal receiving layer or print receiving layer or laminating layer—is comprised substantially of Total PP 3374HA. Optionally, this layer can also include an amount of antiblock or antiblock masterbatch to aid in web handling. Typical amounts of inorganic antiblock can be up to 1000 ppm of the metal receiving layer (A) (preferably, 300-600 ppm) and can comprise of silicas, amorphous sodium calcium aluminum silicates, PMMA, or crosslinked silicone polymer of nominal 1.0-6.0 μm particle size, preferably 2.0-3.0 μm particle size. A preferred embodiment is to use this layer (A) as a metal receiving layer for metallization.

The core layer (B) is comprised substantially of Total HDPE 9658 and Total PP 3271, the amount of Total HDPE 9658 used was from about 10% to about 90% of the total weight of the core layer. A preferred amount was about 20 wt % to 40 wt % Total HDPE 9658 in the core layer.

The sealable skin layer (C), which was comprised substantially of Sumitomo PP SPX78R6, can also optionally include an amount of Mizusawa Silton® JC-30 3 um antiblock masterbatch of ca. 6% by weight or Momentive Tospearl® 130 3 um antiblock masterbatch of ca. 6% by weight of layer (C) to give an amount of antiblock loading of the sealant layer of about 3000 ppm.

### WORKING EXAMPLES

### Example 1

A 3-layer BOPP film was made by the process described above using a core layer (B) formulation of 10 wt % Total HDPE 9658 and 90 wt % Total PP 3271 of the core layer. The non-sealable layer (A) consisted of 100 wt % Total PP 3374HA. The sealant layer (C) consisted of 100 wt % Sumitomo PP SPX78R6.

### Example 2

Example 1 was repeated except that the core layer (B) blend was changed to: 20 wt % Total HDPE 9658 and 80 wt % Total PP 3271.

### Example 3

Example 1 was repeated except that the core layer (B) composition was changed to 30 wt % Total HDPE 9658 and 70 wt % Total PP 3271.

### Example 4

Example 1 was repeated except that the core layer (B) composition was changed to 40 wt % Total HDPE 9658 and 60 wt % Total PP 3271.

### Example 5

Example 1 was repeated except that the core layer (B) composition was changed to 50 wt % Total HDPE 9658 and 50 wt % Total PP 3271.

### Example 6

Example 1 was repeated except that the core layer (B) composition was changed to 60 wt % Total HDPE 9658 and 40 wt % Total PP 3271.

### Example 7

Example 1 was repeated except that the core layer (B) composition was changed to 70 wt % Total HDPE 9658 and 30 wt % Total PP 3271.

### Example 8

Example 1 was repeated except that the core layer (B) composition was changed to 80 wt % Total HDPE 9658 and 20 wt % Total PP 3271.

### Example 9

Example 1 was repeated except that the core layer (B) composition was changed to 90 wt % Total HDPE 9658 and 10 wt % Total PP 3271.

### Comparative Example 1

Example 1 was repeated except that the core layer (B) composition was changed to 100 wt % Total PP 3271. No HDPE resin was added to the core.

The BOPP films were then tested for haze, gloss, heat shrinkage, and mechanical properties. Selected examples were also metallized and tested for oxygen and moisture vapor transmission rates,

The following Table 1 illustrates the properties of these examples:

TABLE 1

| | Core Layer (B) | | | | | | | | Avg. | | | | |
|---|---|---|---|---|---|---|---|---|---|---|---|---|---|
| | Composition | | | | | | | Average | puncture | | MVTR | MVTR | O2TR |
| | wt % | | | | | | Ult | max | energy | Heat | clear | metallized | metallized |
| | Total | Total | | | Modulus | Elongation | Strength | puncture | @50% | Shrink | film | film | film |
| | HDPE | PP | Haze | | MD/TD | MD/TD | MD/TD | load | strain | MD/TD | g/100 | g/100 | cc/100 |
| Example | 9658 | 3271 | % | Gloss | kpsi | % | kpsi | kgf | mJ | % | in2/day | in2/day | in2/day |
| CEx. 1 | 0 | 100 | 3.0 | 109 | 205/254 | 248/72 | 22/37 | 2.0 | 72.0 | 3.0/6.0 | 0.4780 | 0.0665 | >10.0 |
| Ex. 1 | 10 | 90 | 4.0 | 102 | 248/327 | 207/56 | 32/45 | 2.4 | 98.4 | 8.8/6.3 | 0.3923 | 0.0073 | 1.944 |
| Ex. 2 | 20 | 80 | 4.0 | 95 | 248/290 | 208/77 | 29/43 | 2.1 | 83.8 | 8.0/7.5 | 0.4405 | 0.0117 | 2.335 |
| Ex. 3 | 30 | 70 | 4.0 | 93 | 249/307 | 202/65 | 29/41 | 1.9 | 65.9 | 8.5/13.0 | 0.4318 | 0.0089 | 2.389 |
| Ex. 4 | 40 | 60 | 4.0 | 92 | 172/363 | 229/63 | 26/36 | 1.7 | 58.4 | 7.0/12.5 | 0.4838 | 0.0144 | 4.810 |
| Ex. 5 | 50 | 50 | 4.0 | 94 | 152/252 | 204/69 | 17/23 | 1.6 | 60.5 | 4.0/12.5 | 0.4696 | 0.0154 | 3.150 |
| Ex. 6 | 60 | 40 | 4.0 | 99 | 177/256 | 225/70 | 15/20 | 1.3 | 45.3 | 2.5/13.5 | 0.4831 | 0.0159 | 3.032 |
| Ex. 7 | 70 | 30 | 4.0 | 101 | 222/253 | 213/67 | 11/12 | 0.9 | 25.3 | 2.0/14.5 | 0.4465 | 0.0193 | 3.924 |
| Ex. 8 | 80 | 20 | 5.0 | 100 | 239/240 | 171/65 | 11/8 | 0.4 | 8.5 | 14.5/22.0 | 0.5028 | 0.0689 | 2.688 |
| Ex. 9 | 90 | 10 | NA | NA | NA | NA | NA | NA | NA | NA | NA | NA | NA |

As Table 1 shows, Comparative Example 1 (CEx 1), which is a control film of a biaxially oriented clear PP film showed high moisture vapor transmission rate (MVTR), i.e., poor moisture barrier of the Examples. After metallizing, gas barrier properties were poorest of the examples.

Examples 1 and 2 (Ex 1 and Ex 2) added 10 wt % and 20 wt % respectively of high density polyethylene to the core layer. The film optical properties did not change much compared to control, as demonstrated by low haze and high gloss values. However, moisture vapor transmisison rate was lower than CEx, 1 due to the barrier effect of the added HDPE. Tensile properties were comparable or better than CEx. 1, and puncture resistance was improved, indicating retention or improvement of mechanical properties of the BOPP film. Heat shrinkage was worsened however, but could probably be improved with optimization of annealing conditions. Surprisingly, moisture and oxygen barrier properties after metallization were significantly improved over CEx, 1.

Examples 3 and 4 (Ex 3 and Ex 4) added 30 wt % and 40 wt % respectively of high density polyethylene to the core layer. Results for optical properties and mechanical properties were comparable to Examples 1 and 2. Moisture barrier properties of the clear films were comparable or improved over CEx 1, and moisture barrier properties after metallization were also surprisingly improved over CEx 1 and comparable to Examples 1 and 2.

Examples 5, 6 and 7 (Ex 5, Ex 6 and Ex 7) added 50 wt %, 60% and 70 wt % respectively of high density polyethylene to the core layer. Results for optical properties were comparable to Examples 1 and 2, but at these levels of HDPE in the core layer tensile properties were lower than Examples 1 and 2, though still comparable to CEx1. Puncture resistance values were lower at these conditions. Moisture barrier properties of the clear films were comparable to CEx 1, and moisture barrier properties after metallization were still surprisingly improved over CEx 1 and comparable to Examples 1 and 2.

Example 8 (Ex 8) used 80 wt % of high density polyethylene added to the core layer. Optical properties were still comparable to Examples 1 and 2, although haze was higher, and still comparable to CEx 1. MD/TD modulus values were still comparable to Examples 1 and 2 and CEx 1, but the other Mechanical properties were the lowest of the Examples. Heat shrinkage was also poor, the highest of the Examples. Moisture barrier of the clear film was worse than all the Examples, however, moisture barrier of the metalized film was still compared to CEx 1, although much worse than the other examples containing HDPE in the core.

Example 9 (Ex 9) used 90 wt % of high density polyethylene added to the core layer. At this ratio of core layer blend, no film could be made at the previously described BOPP tentering conditions due to sticking of the film to the tenter chain clips; thus no testing could be done. It appears that thermal stability of the core layer was worsened such that the exposed core layer in contact with the tenter chain clip surfaces stuck to said clips causing film tears and process instability. Without being bound by any theory, it is hypothesized that at this blend ratio of 90 wt % HDPE, a phase inversion occurred such that the core layer behaved more like HDPE than like PP and film could not be tentered at said OPP tentering/stretching conditions. It is presumed that film could have been made at this blend ratio by modifying tenter temperatures (i.e. lower preheat and stretching temperatures) and/or using clip cooling technologies.

In conclusion, the use of high density polyethylene blended with polypropylene can be an effective method to improve moisture barrier properties of BOPP films. Mechanical properties of the film can also be maintained adequately compared to standard BOPP film. Indeed, the use of HDPE blended with PP provide properties that are comparable to or better than standard BOPP with the added benefit of improved moisture barrier on both the clear film and metalized film. Surprisingly, the inventors have found that such blends can be made using up to 80 wt % HDPE in the core layer without having to change process conditions from standard BOPP conditions. Thus, an added advantage is that these HDPE/PP blends can be made into biaxially oriented films using BOPP film-making assets and at BOPP processing conditions; this improves productivity and costs of such HDPE/PP blended core layer films.

Test Methods

The various properties in the above examples were measured by the following methods:

Transparency of the film was measured by measuring haze of a stack of 8 sheets of film substantially in accordance with ASTM D1003.

Gloss of the film was measured by measuring the desired side of a single sheet of film via a surface reflectivity gloss meter (BYK Gardner Micro-Gloss) substantially in accordance with ASTM D2457. The A-side was measured at a 60° angle; the C-side or sealant layer side was measured at a 20° angle.

Light transmission of the film was measured by measuring light transmission of a single sheet of film via a light transmission meter (BYK Gardner Haze-Gard Plus) substantially in accordance with ASTM D1003.

Tensile properties such as Young's modulus, ultimate strength, and elongation are measured substantially in accordance with ASTM D882.

Moisture transmission rate of the film was measured by using a Mocon Permatran 3/31 unit substantially in accordance with ASTM F1249. In general, preferred values of MVTR would be less than 5 g/m²/day at 38° C. and 90% relative humidity, and preferably less than 1.5 g/m²/day.

Oxygen transmission rate of the film was measured by using a Mocon Oxtran 2/20 unit substantially in accordance with ASTM D3985. In general, preferred values of O₂TR would be equal or less than 46.5 cc/m²/day and preferably 30 cc/m²/day or less at 23° C. and 0% relative humidity.

1. A biaxially oriented film comprising a core layer (B) comprising a blend of a high density polyethylene and a crystalline polypropylene, wherein the biaxially oriented film has a lower moisture vapor transmission rate than that of a biaxially oriented polypropylene (BOPP) film have a same structure and composition as that the biaxially oriented film except the BOPP film has the core layer (B) containing 100 wt % of the crystalline polypropylene.

2. The biaxially oriented film of claim 1, wherein the crystalline polypropylene comprises a mini-random crystalline polypropylene homopolymer.

3. The film of claim 1, wherein the crystalline polypropylene comprises a crystalline polypropylene homopolymer.

4. The biaxially oriented film of claim 2, wherein the mini-random crystalline polypropylene homopolymer comprises an antiblock.

5. The biaxially oriented film of claim 4, wherein the antiblock comprises a silicate antiblock.

6. The biaxially oriented film of claim 1, wherein an amount of high density polyethylene is about 10-80 wt % of the base layer.

7. The biaxially oriented film of claim 1, wherein the biaxially oriented film has a moisture vapor barrier of less than 0.5 g/100 in²/day.

8. The biaxially oriented film of claim 1, further comprising a metal layer on at least one side of the core layer.

9. The biaxially oriented film of claim 8, wherein the metal layer has an optical density of 2.0-4.0.

10. The biaxially oriented film of claim 8, wherein the metal layer comprises aluminum.

11. The biaxially oriented film of claim 8, wherein the biaxially oriented film has an oxygen gas barrier of less than 5.0 cc/100 in²/day and moisture vapor barrier of less than 0.05 g/100 in²/day.

12. The biaxially oriented film of claim 8, wherein the biaxially oriented film has an oxygen gas barrier of less than 3.0 cc/100 in²/day and moisture vapor barrier of less than 0.02 g/100 in²/day.

13. A method of manufacturing the biaxially oriented film of claim 1, the method comprising manufacturing the biaxially oriented film on a sequential orientation manufacturing line using film-making conditions and tentering temperatures for manufacturing the BOPP film.

14. A method of manufacturing the biaxially oriented film of claim 1, the method comprising manufacturing the biaxially oriented film on a simultaneous orientation manufacturing line using film-making conditions and tentering temperatures for manufacturing the BOPP film.
